(19) United States
(12) Patent Application Publication
(10) Pub. No.: US 2025/0182637 A1
(43) Pub. Date: Jun. 5, 2025

(54) Providing Learning Content

(71) Applicant: Siemens Aktiengesellschaft, München (DE)

(72) Inventor: Martin Kramer, Gauting (DE)

(73) Assignee: Siemens Aktiengesellschaft, München (DE)

(21) Appl. No.: 18/842,266

(22) PCT Filed: Jun. 5, 2023
(86) PCT No.: PCT/EP2023/064988

§ 371 Date: Aug. 28, 2024

(30) Foreign Application Priority Data
Jun. 14, 2022 (DE) 10 2022 205 987.5

(51) Int. Cl. G09B 5/06

(52) U.S. Cl. CPC G09B 5/06

(57) ABSTRACT

Various embodiments include a method for delivering learning content to a person using an electronic computing device. An example method includes: acquiring learning content through an input device of the electronic computing device; analyzing the learning content to identify a learning objective and a fact with the electronic computing device; producing a narration using the learning objective and the fact, the narration containing the learning objective and the fact, using the electronic computing device; and delivering the narration to the person using an output device of the electronic computing device.

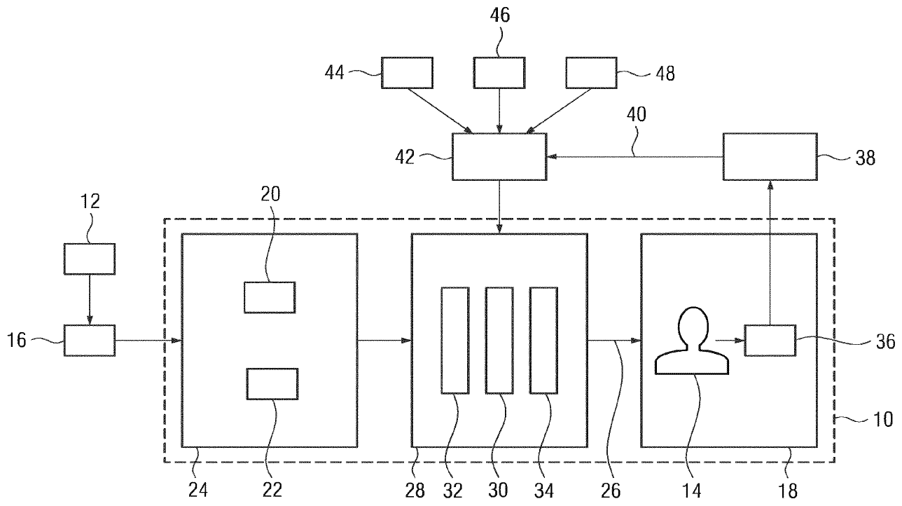

### CROSS-REFERENCE TO RELATED APPLICATIONS

This application is U.S. National Stage Application of International Application No. PCT/EP2023/064988 filed Jun. 5, 2023, which designates the United States of America, and claims priority to DE Application No. 10 2022 205 987.5 filed Jun. 14, 2022, the contents of which are hereby incorporated by reference in their entirety.

### TECHNICAL FIELD

The present disclosure relates to learning. Various embodiments of the teachings herein include systems and/or methods for delivering learning content to a person with an electronic computing device.

### BACKGROUND

It is already known that the limited intake and storage capacity of the human brain can lead to problems with learning experiences. Learnt material is usually taken in and permanently stored only when the information can be taken in and/or experienced, or learned, in particular in an emotionalized manner. Before the invention of the written form, transfer was limited to verbal conveyance, in particular so-called, oft-cited, storytelling around the campfire, and focused on drama in order to convey important content to the audience with lasting effect.

Current solutions to the problem are based on human achievement and are represented in the field of education, motivational speakers or fiction and poetry, in particular in the case of written books and audiobooks. In cognitive teaching, several methods are known that can be used as a vehicle for imagination and stronger association, for example the so-called method of loci, which generally requires individual application by the learner. In particular, no technical implementations are yet known or discoverable in the field of the art, however.

### SUMMARY

The teachings of the present disclosure provide methods, computer program products, computer-readable storage media, and electronic computing devices that can be used to deliver, or impart, a learning content to a person in an improved manner. For example, some embodiments include a method for delivering a learning content (12) to a person (14) by means of an electronic computing device (10), in which the learning content (12) is acquired by means of an input device (16) of the electronic computing device (10) and is broken down into at least one learning objective (20) and at least one fact (22) by means of the electronic computing device (10), and the at least one learning objective (20) and the at least one fact (22) are taken as a basis for producing a narration (26) containing the at least one learning objective (20) and the at least one fact (22) by means of the electronic computing device (10), and the narration (26) is output for the person (14) by means of an output device (18) of the electronic computing device (10).

In some embodiments, the learning content (12) is broken down into at least the learning objective (20) and the fact (22) by means of a machine learning of the electronic computing device (10).

In some embodiments, the narration (26) is produced on the basis of the learning objective (20) and the fact (26) by means of a machine learning of the electronic computing device (10).

In some embodiments, a text-form-based narration (26) and/or a narration (26) in auditory form and/or a narration (26) in visual form is produced.

In some embodiments, the electronic computing device (10) is used to determine a content (30) of the narration (26).

In some embodiments, the learning objective (20) and/or the fact (22) is/are taken as a basis for adjusting the content (30).

In some embodiments, the content (30) and/or the learning objective (20) and/or the fact (22) is/are taken as a basis for determining a structure (34) of the narration (26).

In some embodiments, an observation device (36) of the electronic computing device (10) is used to observe the person (14), and an observed parameter (38) characterizing the person (14) is taken as a basis for determining an efficiency review with respect to the learning content (10).

In some embodiments, the observation device (36) is provided as a camera for capturing the person (14).

In some embodiments, the efficiency review is taken as a basis for determining an adjustment parameter (40), and the adjustment parameter (40) is taken into account for a future delivery of a future learning content (12) to the person (14).

In some embodiments, a personal profile (42) of the person (14) is specified for the electronic computing device (10), and the narration (26) is additionally produced on the basis of the personal profile (42).

In some embodiments, the personal profile (42) takes account of a genre preference (44) of the person (14) and/or an association (46) of the person (14) and/or a prior knowledge (46) of the person (14).

As another example, some embodiments include a computer program product containing program code means that, when the program code means are executed by an electronic computing device (10), cause the electronic computing device (10) to carry out one or more of the methods as described herein.

As another example, some embodiments include a computer-readable storage medium containing a computer program product as described herein.

As another example, some embodiments include an electronic computing device (10) for delivering a learning content (12) to a person (14), having at least one input device (16) and an output device (18), the electronic computing device (10) being configured to carry out one or more of the methods as described herein.

### BRIEF DESCRIPTION OF THE DRAWINGS

The FIGURE that follows uses a schematic block diagram to show an example embodiment of an electronic computing device. In the FIGURE, identical or functionally identical elements are provided with the same reference signs.

### DETAILED DESCRIPTION

Some embodiments of the teachings herein include a method for delivering a learning content to a person by means of an electronic computing device, in which the learning content is acquired by means of an input device of the electronic computing device and is broken down into at least one learning objective and at least one fact by means of the electronic computing device, and the at least one learning objective and the at least one fact are taken as a basis for producing a narration containing the at least one learning objective and the at least one fact by means of the electronic computing device, and the narration is output for the person by means of an output device of the electronic computing device.

Some embodiments include an electronic computing device by means of which the learning content can be delivered, or imparted to the person, in an improved manner. In particular, the learning content can thus be broken down into the learning objective and the at least one fact, in particular a multiplicity of facts, and the determined learning objective and the determined fact can in turn be taken as a basis for recounting a narration, allowing the person to take in the learning content in an emotionalized manner. The person can thus take in the learning content in an improved manner. The narration can also be considered substantially similar to a story or an account.

In some embodiments, the learning content, or the cognitively existing information source, is thus, in multiple steps, analyzed, broken down, divided and generated as a narration with, for example, visualization, in order to associate important facts from the original information with elements of the narration and, for example, to visually embed said facts.

In some embodiments, this learning content can thus be converted into the narration in an automated manner. As a result of the automation, a generated narration is available in real time and it is possible to react to the user behavior immediately. Automation also eliminates costs arising from manual labor, and the efficiency of learning and delivering the learning content thus increases. An illustrative scientific basis for emotionalized learning that can be considered in this regard is the book “Lebenslanges Lernen und Emotionen: Wirkungen von Emotionen auf Bildungsprozesse aus beziehungstheoretischer Perspektive” by Wiltrud Giesecke, 3rd edition of adult education and lifelong learning from 2016.

In some embodiments, the learning content is broken down into at least the learning objective and the fact by means of a machine learning of the electronic computing device. In particular, a neural network may have configured the electronic computing device to break down the learning objective and the fact. By way of example, this can be accomplished by providing a trained neural network that can in turn take already existing learning content and narrations as a basis for producing an applicable breakdown. In particular, the neural network may be in the form of a learning neural network and, by way of example, can also make applicable changes in future, for example on the basis of an efficiency review. By way of example, the neural network can be provided as a convolutional neural network. In some embodiments, the neural network can also be provided as a perceptron, as a feedforward neural network or as a recurrent neural network or generative adversarial networks (GANs).

In some embodiments, a machine learning of the electronic computing device is used to take the learning objective and the fact as a basis for producing the narration. In particular, a neural network may have configured the electronic computing device to produce the narration in accordance with the specifications, that is to say the learning objective and the fact. By way of example, this can be accomplished by providing a trained neural network that can in turn take already existing learning content and narrations as a basis for producing an applicable breakdown. In particular, the neural network may be in the form of a learning neural network and, by way of example, can also make applicable changes in future, for example on the basis of an efficiency review. By way of example, the neural network can be provided as a convolutional neural network. In some embodiments, the neural network can also be provided as a perceptron, as a feedforward neural network or as a recurrent neural network or generative adversarial networks (GANs).

In some embodiments, a narration in auditory form and/or a narration in visual form is produced as a text-form-based narration and/or a narration in auditory form and/or a narration in visual form. By way of example, the narration can be produced in the form of a text form, for example as prose text, by the electronic computing device. In some embodiments, some or all of the narration can also be output in an auditory manner, that is to say on the basis of listening comprehension, for example in the form of an audiobook. In addition, a narration in visual form, for example in the form of images or a film, in particular accompanied by auditory or text-form-based titles, can also be produced. This permits the narration to be produced at different perception levels, thereby allowing the narration to be recounted, or the learning content to be imparted, in an improved manner.

In some embodiments, the electronic computing device is used to determine a content of the narration. By way of example, the content can differ from the learning content. By way of example, the learning content may be a biological function for animals, while the content of the narration then in turn relates to a narration from an animal kingdom and thus the learning content is “hidden in the content”.

In some embodiments, the learning objective and/or the fact is/are taken as a basis for adjusting the content. In particular, the content for the narration can thus also be adjusted, or the content is adjusted to suit the learning objective or the fact. By way of example, the learning content may be applicable specific imparting of knowledge, for example the exact arrangement of extremities of human beings. A corresponding narration containing a content can then be adapted therefor, for example a hospital stay by a person with a broken arm, the narration then in turn detailing the exact configuration of the arm and thus imparting the learning content, specifically the design of human extremities, to the person.

In some embodiments, the content and/or the learning objective and/or the fact is/are taken as a basis for determining a structure of the narration. In particular, the narration can thus also have an introduction, a main part and a conclusion, and so a corresponding improved imparting of knowledge can be produced in an emotionalized manner, or in an emotion-based manner. In some embodiments, a preferred genre of the person can be taken as a basis for determining the structure of the narration. This allows the person to take in the learning content in an improved manner.

In some embodiments, an observation device of the electronic computing device is used to observe the person, and an observed parameter characterizing the person is taken as a basis for determining an efficiency review with respect to the learning content. In particular, the electronic computing device may thus be configured to monitor efficiency through user observation and can in turn adjust the applicable parameters for efficiency so that an improved learning content presentation can be produced in future. By producing the observation device that is used, which is provided in particular in the form of an attention monitor, the efficiency of the generated narration can be measured and if necessary improved, for example by modifying the preferences that are reported back.

In some embodiments, the observation device is provided as a camera for capturing the person. By way of example, so-called eye tracking, or interaction monitoring, can be carried out by means of the camera or without a camera. By way of example, a pointer trail, or a mouse movement profile, may also be able to be used for observation. The camera should be regarded as purely illustrative and in no way conclusive in this instance; by way of example, it is also possible to capture reactions via the input device in an appropriate manner or to measure other parameters pertaining to the person, for example a pulse rate or a body temperature, in order to be able to carry out appropriate attention monitoring. There may be provision in this instance for applicable sensors, or devices, that can then in turn produce the eye tracking, the interaction monitoring, a pulse measurement or a temperature measurement.

In some embodiments, observation devices may be keyboard containing pressure sensors, with the result that dynamic and/or fast keystrokes by the learner can be rendered distinguishable from hesitantly cautious keystrokes and this distinction is logged as data and becomes storable. Similarly, the use of a mouse, trackball, touchpad, touchscreen, stylus and/or joystick can be detected and stored in an appropriate manner. Moreover, the use of all types of “Delete” inputs, or “Delete operations”, using keys, using a mouse, using a touchscreen, etc., can be recorded and analyzed.

In some embodiments, heart rate, pulse, blood pressure and other physical data, which can be acquired for example by wristwatches and/or by camera, can be incorporated into the system and used to detect the situation of the learner in the case of various learning content. In addition, oxygen content in the air, room temperature, etc., can be measured and data can be generated, analyzed, compared and fed into the system in order to optimize learning success.

Data for detecting the situation are generated by appropriately mounted recording such as a camera, one or more microphone(s) and/or field effect microphone(s), pressure sensor(s), tracking of the movement-path and speed-of an input device such as a mouse, touchscreen, stylus, trackball, joystick. In some embodiments, the generated data are compared with the time characteristic of the simultaneously running learning content and analyzed with regard to the content thereof and the “normal” “unexcited” behavior of the learner and/or learners and/or of other learners. Carriage of the time base relating to the data generated by the observation device(s) is optional but may be very useful for producing a time axis and/or a concentration profile.

An appropriate video recording and optically and/or acoustically or otherwise generated datasets also allow the body posture, the gestures and/or the movement profile of the learner/learners in relation to the learning content to be used in an automated manner for comprehension, for detecting the situation of the learner and for adjusting the learning content to suit the learner. As such, running around the room, the type and frequency of the head movement, facial expressions, micro-expressions, facial recognition, rotation of the upper body, rolling of the eyes, yawing and/or nodding, shrugging can be detected, used as a data block employed for training an appropriate AI that progressively and dynamically adjusts the learning content to suit the automatically detected mood of the learner/learners.

The data relating to detection of the situation of learners studying a learning content can accordingly also be employed for motivation. When appropriate match values are attained, there are then e.g. motivation actions that take place automatically. Examples of these motivation actions are e.g. pop-up of smileys, sounds, clapping, music, offer of a beverage/sweet and/or a fruit—may be held in a refrigerator belonging to the system—and/or emojis that appear in a manner suited to the learning content and/or to the learner and reward the learner, or even simply a break when the system detects and/or analyzes that the learner/learners are exhausted.

On the other hand, a tendency toward precrastination or procrastination can also be identified in this way. Analysis of the acquired data relating to the situation of the learner in the case of the different learning content can be used for example to establish whether the learner exhibits less tendency toward anxious, overhasty or otherwise “conspicuous” behavior in the case of one or the other learning content. The chronology of the learning content can then be automatically adjusted by AI such that the learner is always optimally in the mood for the respective learning content.

Moreover, the system can use gentle invitation, for example in order to animate a procrastinator, to take up the learning task. This may also involve playful invitations in accordance with a gamification, or rewards such as “if you manage this today, you will then have the benefit”, and/or it may be coupled to motivation actions—see above.

In some embodiments, the efficiency review is taken as a basis for determining an adjustment parameter, and the adjustment parameter is taken into account for a future delivery of a learning content to the person. By way of example, it is possible to determine what the attention span of the observer was like. By way of example, it is possible to determine that the observer had an increased attention level for only five minutes and the attention span fell again from the fifth minute onward. The adjustment parameter may thus be of a nature such that in future the learning content is reduced only to narrations that are in five minute form. In addition, other parameters can also be adjusted in an appropriate manner in order to be able to present the learning content in an appropriately improved manner.

In some embodiments, a personal profile is specified for the electronic computing device, and the narration is additionally recounted on the basis of the personal profile. The narration can thus in turn be recounted in a manner individually tailored to the person. In particular, the personal profile can also be referred to as a user preference.

In some embodiments, a personal profile takes account of a genre preference of the person and/or an association of the person and/or a prior knowledge of the person. The narration, or user preference, and the personal profile can thus be produced reliably. The applicable preferences, or associations, and the prior knowledge can be produced for example on the basis of an observation of the person in a period in the past. In some embodiments, the applicable parameters, in particular the genre preference, the association and the prior knowledge, can be specified by the person or by other persons and thus made available to the electronic computing device. In the case of the genre preference, it is possible for example to specify that the person preferably watches thrillers and/or cartoons. Accordingly, such a genre can be taken into account. Furthermore, past experiences, for example a holiday, can be used to deliver appropriate learning content via associations. In addition, prior knowledge, for example a previously visited educational institution, a training or studies, can be used to personalize the narration.

Some embodiments of the teachings herein include an electronic computing device for delivering a learning content to a person, having at least one input device and an output device, the electronic computing device being configured to carry out one or more of the methods described herein. In particular, one of the methods may be carried out by means of the electronic computing device.

In some embodiments, the electronic computing device has processors, circuits, in particular integrated circuits, and other electronic components in order to be able to carry out applicable method steps. In particular, the method is carried out by means of the electronic computing device.

The configurations of the method can be considered as configurations of the computer program product, the computer-readable storage medium and the electronic computing device. The electronic computing device has in particular components in order to be able to carry out applicable method steps. For applications or application situations that can arise with the method and that are not described explicitly here, there may be provision for the method to involve an error message and/or an invitation to input user feedback being output and/or a standard setting and/or predetermined initial state being selected.

The figure shows a schematic block diagram of an example electronic computing device 10 incorporating teachings of the present disclosure. The electronic computing device 10 is configured to deliver a learning content 12 to a person 14 and has at least one input device 16 and an output device 18.

An example method for delivering the learning content 12 by means of the electronic computing device 10 involves the learning content 12 being acquired by means of the input device 16 and broken down into at least one learning objective 20 and at least one fact 22 by means of the electronic computing device. The learning content 20 may be existing, unprocessed information or implicitly or explicitly specified. In some embodiments, there may be a so-called information extraction module 24 for this purpose, this in turn being able to be provided in particular as a neural network.

The at least one learning objective 20 and the at least one fact 22 is/are taken as a basis for producing a narration 26 containing the at least one learning objective 20 and the at least one fact 22 by means of the electronic computing device 10. This can be carried out in particular in a narration generation module 28, the narration generation module 28 in turn also being able to be in the form of a neural network. The narration 26 is then in turn output for the person 14 by means of the output device 18.

As already mentioned, the learning content 12 can be broken down into at least the learning objective 20 and the fact 22 in particular by means of machine learning of the electronic computing device 10, the machine learning in the present case being represented in particular by the neural network, or the information extraction module 24. In some embodiments, the narration 26 to be produced on the basis of the learning objective 20 and the fact 22 by means of a machine learning of the electronic computing device 10. In the present case, this is provided in particular via a neural network, and is shown in particular by way of the narration generation module 28.

In particular, the electronic computing device 10 can be used to produce a content 30, or a corresponding storyline. In particular, the learning objective 20 and/or the fact 22 can be taken as a basis for adjusting, or adapting, the content 30, which is predominantly shown in a mapping module 32. In addition, there may be provision for the content 30 and/or the learning objective 20 and/or the fact 22 to be taken as a basis for determining a structure 34 of the narration 26.

The narration 26 may be in particular in text-form-based and/or auditory form and/or in visual form.

In some embodiments, there may be an observation device 36, which is in particular in the form of a camera, of the electronic computing device 10 to be used to monitor the person 14 and for an observed parameter 38 characterizing the person, for example an attention level of the person 14, to be taken as a basis for determining an efficiency review with respect to the learning content 12. The observation device 36 may be in particular an attention monitor and can be provided for example in the form of an eye tracker.

In some embodiments, the efficiency review may be taken as a basis for determining an adjustment parameter 40 and for the adjustment parameter 40 to be taken into account for a future delivery of a learning content 12, in particular a future learning content 12, to the person 14.

In the exemplary embodiment that follows, the adjustment parameter 40 can in turn be used for a personal profile 42. This personal profile 42, or user profile, can in turn be taken as a basis for producing the narration 26, the personal profile 42 in turn being able to be specified for the electronic computing device 10. The personal profile 42 can in turn take account of a genre preference 44 and/or an association 46 and/or a prior knowledge 48 of the person 14.

In particular, the figure thus shows that the cognitively existing information source, or the learning content 12, is, in multiple steps, analyzed, broken down, divided and generated as the narration 26 with, for example, visualization, in order to associate important facts from the original information with elements of the narration 26 and to visually embed said facts.

In some embodiments, an automotive attention level alerter uses a measured input for notifications and recommendations or is configured to shut down auxiliary systems, but not to fundamentally change system functions. That is to say that in the automotive sector the alerter acts only within predefined degrees of freedom, whereas the system outlined here generates completely different outputs if the expected user behavior fails to appear.

In particular, in a first step, the learning content 12 is thus transformed in an automated manner. The narration 26 is produced individually for the respective user, or for the person 14. The attention monitor can then be used to measure and if necessary improve the efficiency of the generated narration 26.

As a result of the automation, a generated narration 26 is available in real time and it is possible to react to the user behavior immediately. Automation eliminates costs arising from manual labor, and efficiency rises accordingly. The step of user individualization has resulted in the person 14 experiencing a learning experience matched to their cognitive capabilities and their personal preferences. Marginal cost problems mean that this is attainable only through automation and evaluation. The system, or the electronic computing device 10, monitors efficiency by way of user observation and adapts/improves its own parameters for the improved efficiency of the individualization. The information extraction makes use of methods of information gathering such as natural language processing, learning and generating knowledge graphs and ontologies and also generative technologies, for example natural language generation (NLG) and sequence-to-sequence transformation (Seq2Seq).

### LIST OF REFERENCE SIGNS

10 electronic computing device
12 learning content
14 person
16 input device
18 output device
20 learning objective
22 fact
24 information extraction module
26 story
28 story generation module
30 content
32 mapping module
34 structure
36 observation device
38 parameter
40 adjustment parameter
42 personal profile
44 genre preference
46 association
48 prior knowledge

What is claimed is:

1. A method for delivering learning content to a person using an electronic computing device, the method comprising:
acquiring learning content through an input device of the electronic computing device;
analyzing the learning content to identify a learning objective and a fact with the electronic computing fact device;
producing a narration using the learning objective and the fact, the narration containing the learning objective and the fact, using the electronic computing device; and
delivering the narration to the person using an output device of the electronic computing device..

2. The method as claimed in claim 1, wherein the learning content is broken down into the learning objective and the fact with a machine learning of the electronic computing device.

3. The method as claimed in claim 1 wherein producing the narration includes using a machine learning of the electronic computing device.

4. The method as claimed in claim 1, wherein the narration includes a text-form-based narration and/or a narration in auditory form and/or a narration in visual form.

5. The method as claimed in claim 1, wherein the electronic computing device determines a content of the narration.

6. The method as claimed in claim 5, further comprising using the learning objective and/or the fact for adjusting the content.

7. The method as claimed in claim 5, wherein the content, the learning objective, and/or the fact are used for determining a structure of the narration.

8. The method as claimed in claim 1, further comprising:
using an observation device of the electronic computing device to observe the person; and
assessing an efficiency of the process using an observed parameter characterizing the person with respect to the learning content.

9. The method as claimed in claim 8, wherein the observation device comprises a camera.

10. The method as claimed in claim 8, further comprising:
using the efficiency review as a basis for determining an adjustment parameter; and
using the adjustment parameter for a future delivery of a future learning content to the person.

11. The method as claimed in claim 1, further comprising;
specifying a personal profile of the person for the electronic computing device; and
producing the narration on the basis of the personal profile.

12. The method as claimed in claim 1, wherein the personal profile notes a genre preference of the person, an association of the person, and/or prior knowledge of the person.

13-15. (canceled)
